(19) United States
(12) Patent Application Publication
(10) Pub. No.: US 2011/0062060 A1
(43) Pub. Date: Mar. 17, 2011

(54) SYSTEM AND METHOD FOR COMMUNICATION BETWEEN A FLUID FILTRATION APPARATUS AND FILTER

(76) Inventors: Paul Royal, Oakville (CA); Peter Zosimadis, Brampton (CA); Michael H. Ward, Toronto (CA)

(21) Appl. No.: 12/829,945

(22) Filed: Jul. 2, 2010

Related U.S. Application Data
(60) Provisional application No. 61/222,995, filed on Jul. 3, 2009.

(51) Int. Cl. B01D 35/14; B01D 35/143; H04Q 5/22

(52) U.S. Cl. 210/85; 210/143; 210/138; 340/10.1

(57) ABSTRACT

A system allowing the wireless transfer of data between a fluid filtering apparatus having a controller and a filter when the filter is positioned within the fluid filtering apparatus is described. The system includes a reader circuit and tag circuit in which the tag circuit includes read-only information and an enable bit responsive to a disable signal from the reader circuit to permanently de-authorize use of the filter with the fluid filtering apparatus. The controller is operatively connected to the reader circuit for interpreting the coded information and may modify or eliminate fluid flow within the fluid filtering apparatus, and/or provide a visible or audible warning to the user on the basis of filter manufacturer specifications such as volume and/or time of filter use.

### CROSS-REFERENCE TO RELATED APPLICATIONS

The present application claims the benefit under 35 U.S.C. §119(e) of the U.S. Provisional Patent Application Ser. No. 61/222,995, filed on Jul. 3, 2009, the content of which is incorporated herein by reference.

### FIELD OF THE INVENTION

A system allowing the wireless transfer of data between a fluid filtering apparatus having a controller and a filter when the filter is positioned within the fluid filtering apparatus is described. The system includes a reader circuit and tag circuit in which the tag circuit includes read-only information and an enable bit responsive to a disable signal from the reader circuit to permanently de-authorize use of the filter with the fluid filtering apparatus. The controller is operatively connected to the reader circuit for interpreting the coded information and may modify or eliminate fluid flow within the fluid filtering apparatus, and/or provide a visible or audible warning to the user on the basis of filter manufacturer specifications such as volume and/or time of filter use.

### BACKGROUND OF THE INVENTION

In many fluid filtering systems the filter should be periodically replaced before obstructions or clogging degrade its operation. The incorrect replacement of a filter, such as installing the wrong type of filter or installing a filter in an incorrect orientation, may prevent the correct operation of a fluid filtering apparatus.

Many fluid filtration products produce revenue for the manufacturer through the sale of filters after the fluid filtration system is purchased. A manufacturer may sell a fluid filtration system at a reduced profit with the understanding that they will make an on-going profit selling fluid filters.

Competitors will often copy the consumable filter and undercut prices of the original equipment manufacturer (OEM) to sell the filter to consumers. As a result, the OEM manufacturers who have invested substantial money in the research and development of their fluid filtration systems continue to look for ways to make it more difficult for their competitors to utilize the competitor's filters within the original equipment.

As one example, there are currently many fluid filter systems that use physical keying systems to prevent unauthorized products from being used within devices. Mechanical keying systems require that the physical geometry between the original filtering equipment and filter must match. Such systems may include physical rings with specific geometry (male and female) that are made to fit together, keyed slots, non-standard dimensions and other systems.

The challenge with physical or mechanical systems is that they are easily defeated either by the competitor or by the consumer. That is, the competitor may simply manufacture filters with similar geometries or the consumer by using various tools will modify the geometry of the OEM filtration apparatus or the competitor's filter to make the products fit, thus defeating the intentions of the OEM.

In the past, other keying systems have been utilized that require both physical and electronic connection between two or more devices. This type of physical/electronic system will often add a significant constraint to the design of the OEM product and is often limited by typical problems associated with maintaining a physical contact between devices such as dirt and water contamination and/or corrosion by environmental factors that may ultimately affect the reliability of the fluid filtration system and lead to customer dissatisfaction.

As a result, there exists a need for an improved system and methodology that enhances the ability of OEM manufacturers from having competitors produce filters that can be utilized with the OEM filtration system.

Removable filters must be replaced after a specified amount of use or period of time. To assist a user in maintaining a fluid filtration system, it is advantageous to provide a visual or auditory warning if a filter needs to be replaced or is not appropriate for use in the fluid filtration apparatus. Furthermore, it is advantageous for a fluid filtration system to automatically modify or eliminate fluid flow on the basis of filter manufacturer, filter model or length of filter use.

In particular, there has been a need for an inexpensive wireless system that provides effective electronic coupling between a filter and fluid filtration system wherein the coupling enables the exchange of information between the devices in order that the origin and/or authenticity of the filter can be determined in order to enable or deny the cooperation between the filter and fluid filtration apparatus.

A review of the prior art reveals that U.S. Pat. No. 5,674,381 has been used in the past for providing electronic coupling between a filter and fluid filtration system. U.S. Pat. No. 5,674,381 discloses a filtering apparatus and replaceable filter having an electronic tagging system wherein the tag associated with the filter is a read/write tag adaptable to store the number of operating hours for the filter.

While the prior art may provide a partial solution, past systems may be limited as they do not suggest or teach the advantages of a tagging system with a passive read-only tag. As is known in the art, read/write tags are expensive to manufacture and install within a filter whereas passive read-only tagging circuits are inexpensive to manufacture.

### SUMMARY OF THE INVENTION

In accordance with the invention, there is provided a system allowing the wireless transfer of data between a fluid filtering apparatus and a filter when the filter is positioned within the fluid filtering apparatus, the system comprising: a reader circuit having a controller operatively connected to the fluid filtering apparatus; and a tag circuit operatively connected to the filter for passive wireless communication with the reader circuit, the tag circuit containing read-only coded information readable by the reader circuit authorizing use of the filter with the fluid filtering apparatus, and wherein the tag circuit includes an enable bit responsive to a disable signal from the reader circuit to permanently de-authorize use of the filter with the fluid filtering apparatus.

In a further embodiment, the disable signal is a high-voltage signal from the reader circuit that causes a permanent change in the enable bit.

In another embodiment, the enable bit is isolated during a clock cycle by a shift register and the reader circuit emits a high voltage pulse to destroy the enable bit.

In further embodiments, after enable bit destruction, the controller may prevent or modify fluid flow through the filter, and/or provide a visible or audible warning to the user and/or the controller will return to normal operation only upon recognition of a new filter having a different serial number and enable bit. The controller may initiate deactivation of the enable bit based on detection of time-of-use or volume-of-use in excess of pre-determined parameters of use for a filter from a manufacturer and/or based on detection of one or more downstream sensor parameters in excess of pre-determined limits of use for a filter from a manufacturer.

In another embodiment, the tag circuit includes an antenna and a fuse operatively connected to the antenna, the fuse being responsive to a disable signal to permanently disable the tag circuit.

In one embodiment, the reader circuit includes a receiver coil and a transmit coil for providing oscillation energy to the tag circuit when the tag circuit is coupled to the reader circuit. The tag circuit may include a tag coil for patterned oscillation at least two discrete frequencies and for coupling to the reader circuit such that the receiver coil, transmit coil and tag coil all oscillate at the same frequency when the reader circuit and tag circuit are coupled and the patterned oscillation is representative of coded information within the tag circuit.

In yet another embodiment, the controller initiates a visual or auditory signal if a filter needs to be replaced or is not appropriate for use in the fluid filtration apparatus.

In alternate embodiment, the invention also provides a method of rendering a filter in a fluid filtration apparatus inoperable, the filter having a tag circuit operatively coupled to a reader circuit having a controller, the method comprising the steps of: using a shift register to isolate an enable bit within the tag identification logic; and applying a disable signal to the tag circuit in order to permanently destroy the enable bit.

In yet another embodiment, the invention provides a method of rendering a filter in a fluid filtration apparatus inoperable, the filter having a tag circuit having a fuse, the tag circuit operatively coupled to a reader circuit having a controller, the method comprising the step of applying a high voltage pulse to the tag circuit to destroy the fuse and to open the tag circuit.

### BRIEF DESCRIPTION OF THE DRAWINGS

The invention is described with reference to the accompanying figures in which:

FIG. 1 is a side view of a fluid filtration system including a conduit for conveying fluids, a filter, a controller and a control system.

FIG. 2 is a schematic diagram of a coupling system in accordance with the invention showing a reader and tag circuit.

FIG. 3 is a schematic diagram of a representative frequency output of a tag circuit in accordance with the invention.

FIG. 4 is a schematic diagram of a coded information subsystem in accordance with one embodiment of the invention;

FIG. 5 is a schematic diagram of a representative example of coded information in accordance with one embodiment of the invention; and

FIG. 6 is a schematic diagram of a tag circuit including a fuse in accordance with one embodiment of the invention.

### DETAILED DESCRIPTION OF THE INVENTION

### Overview

With reference to the figures, a fluid filtration system 10 allowing the wireless transfer of data between a fluid filtration apparatus and a replaceable filter when the filter is operatively positioned within the fluid filtration apparatus is described. The system includes two main circuits, a reader circuit 101 and a tag circuit 102. In the context of this description, the reader circuit 101 may be located on the fluid filtration apparatus and the tag circuit located on the replaceable filter where it is desired that the two products are coupled to enable the interaction and the exchange of information between the two products.

In various embodiments, the fluid filtration system may take appropriate action in response to the system exceeding pre-determined limits on measured variables such as length of filter use, amount of filter use or other criteria set by the manufacturer or if unacceptable levels of contaminants are found downstream of the filter. If the above pre-determined limits are exceeded, the fluid filtration system may destroy the enable bit or blow a fuse in the tag circuit to render the filter inoperable within a fluid filtration apparatus.

### Filter Design and Function

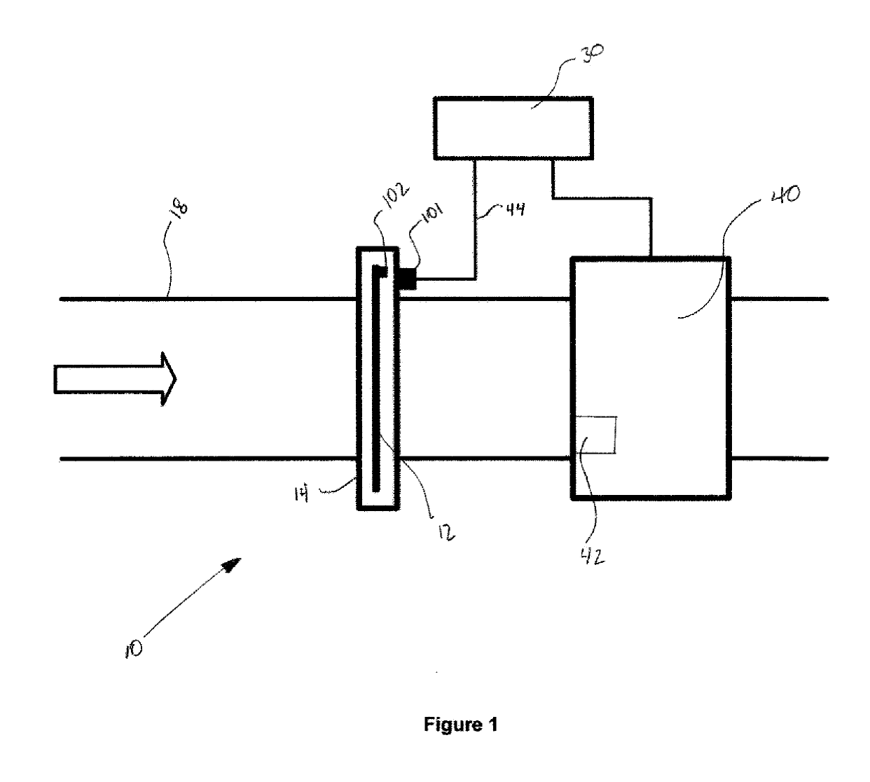

A replaceable filter 12 is preferably a mechanical or chemical filter in which a fluid (liquid or gas) is forced through or adjacent to a membrane or porous material in order to remove solid matter and/or impurities. In accordance with the present invention and shown in FIG. 1, a filter 12 includes a tag circuit 102 for operative communication with a reader circuit 101. The tag circuit 102 is located in the filter such that when the filter is installed in the fluid filtering apparatus, the tag circuit is located in operational proximity to the reader circuit.

### Fluid Filtration Apparatus Design and Function

A fluid filtration system 10 generally includes a conduit 18 to convey fluids, a filter 12, filter casing 14 and controller 30. In a preferred embodiment, a fluid filtration system 10 further includes a control system 40 to regulate fluid flow through the filter apparatus.

A reader circuit 101 may be located in the filter casing and operatively connected to the controller 30 such that when the filter is installed in the fluid filtering apparatus, the tag circuit 102 is located in operational proximity to the reader circuit 101.

In accordance with the invention, the conduit 18 will generally convey fluids through or adjacent to the filter 12 in order to mechanically or chemically remove undesirable solid particulate or other impurities. The fluid flow through the filter may be regulated by the control system 40. The control system may include one or more pumps, valves, baffles or the like (not shown) to increase or decrease fluid flow through the fluid filtration system. The control system may be operatively connected to the controller 30 and located either upstream or downstream of the filter.

Sensors 42 such as manometers, temperature sensors, pressure sensors or the like may be located upstream or downstream the filter and operatively connected to the controller. Sensors may further be designed to measure the chemical composition of the fluid or detect unwanted chemical components.

The controller 30 is operatively connected to the reader circuit 101 through a controller output line 44 and to the control system 40. The controller 30 may receive and interpret data from the reader circuit 101 and sensors 42 and forward instructions to the control system as described below. In a preferred embodiment, the controller 30 may further be connected to a visual display or audible signal or the like for the purpose of communicating the status of the fluid filtration system to a user.

### Reader Circuit Design and Function

The general function of the reader circuit is to read information contained within the tag circuit when the tag circuit is within the operating distance of the reader circuit. Once the tag circuit is within operating distance, coded information contained within the tag will be output to the reader circuit for interpretation. More specifically, the reader circuit includes two uncoupled antennae that require the physical presence of an input antenna within the tag circuit to create a coupled connection and thereby allow the exchange of the coded information.

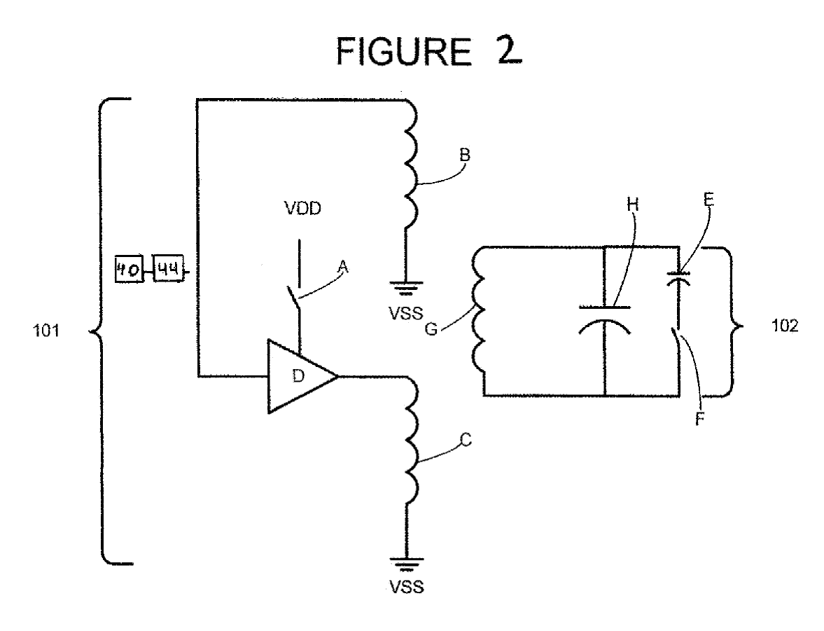

As shown in FIG. 2, in a preferred embodiment, the reader circuit 101 includes a power supply switch A, a receiver antenna B, a transmit antenna C, an amplifier D and a controller output 44. The tag circuit 102 includes an input antenna G, a resonant capacitor H and a logic switch F with a switch capacitor E. In operation, as power to the reader circuit is switched on, the transmit antenna C of the reader will cause the input antenna G of the tag circuit to begin oscillating at the resonate frequencies (as determined by the resonant and switch capacitors of the tag circuit and explained in greater detail below) which will be transmitted to the receiver antenna B whose oscillation output may then be read and interpreted by an appropriate controller 40 through controller output 44.

The receive B and transmit C coils are designed such that they do not have enough gain to self-couple such that it is only through the physical presence of the tag circuit 102 in proximity to the reader circuit that allows enough energy to be coupled between the receive B and transmit C coils to enable oscillation at the resonate frequency of the tag circuit.

The reader circuit is controlled by power switch A such that when the power switch is closed, the circuit operates and when the switch is opened, the circuit is turned off. The placement or location of the switch in a combined pair of reader circuit and tag circuit can be controlled by the physical design of two coupled products.

When power is turned on to power switch A, the transmit coil C is energized and will inherently attempt to couple with receive coil B. As a result of the physical separation and power supply, the receive and transmit coils will not couple unless the tag circuit 101 is within operating range.

As soon as the tag circuit 102 is in range, energy will flow from the transmit coil C into the input coil G, then through B.

In approximately 0.005 seconds, after the introduction of the tag circuit 102, the system is fully oscillating and fully functional.

Once the system is fully oscillating, the reader circuit 101 outputs the oscillation signal (containing coded information within the tag circuit) via output line 44 to a standard controller 40 which can interpret the signal and base decisions on that information.

The transmit coil C can also be used to produce a specific RF signal including a voltage pulse which can disable a special enable bit or melt a fuse on each tag as will be explained in greater detail below.

### Tag Circuit Design and Function

As indicated, the tag circuit includes a resonant capacitor H, a switching capacitor E and a logic driven switch F that in combination allows the cyclical adjustment of the resonant frequency of the tag circuit. In accordance with the present invention, the tag circuit is a read-only circuit that cannot be programmed and does not require a power source.

Generally, the base resonant frequency of the tag circuit is determined by the resonant capacitor H which in combination with input antenna G and resonant capacitor H creates a tuned coil that will naturally resonate at a specific or discrete frequency. In preferred embodiments of the invention, discrete resonant frequencies of the system will be designed to operate at discrete values in the 72 kHz to 900 kHz range, although it is understood that the operating frequency range can be expanded if required by the design of specific fluid filtration systems.

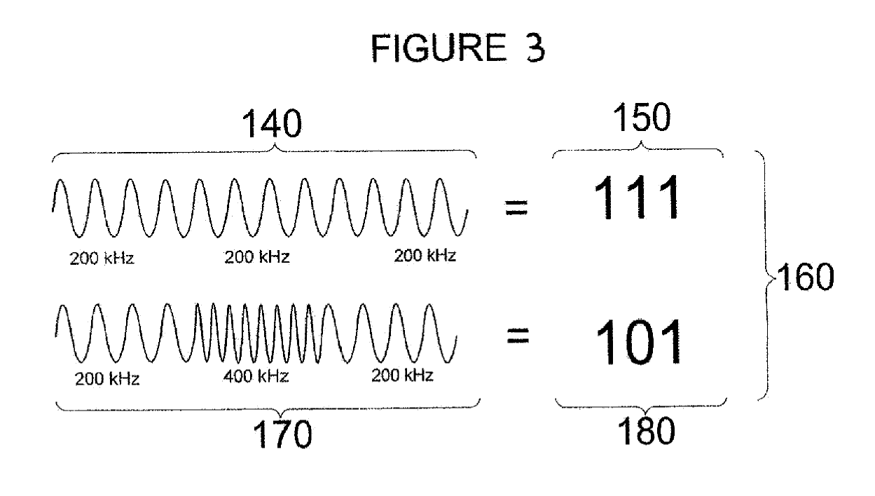

The switching capacitor E and logic controlled switch F are in parallel with the resonant capacitor H and enable the operative change of the resonant frequency of the tag circuit to a second discrete value. As shown in FIG. 3, as the system oscillates, logic controlled switch F will periodically open and close in accordance with its design such that the resonant frequency of the tag will change between two discrete values depending on whether the logic controlled switch is opened or closed.

For example, with the logic switch F open, the system will oscillate at the discrete resonant frequency of the resonant capacitor H and will produce a steady state oscillation signal 140 as shown schematically in FIG. 3.

As the logic switch F is closed, the switching capacitor E is switched into the circuit which will change the discrete resonant frequency of the tag as determined by the combined capacitance of the resonant capacitor H and switch capacitor E. As the switching capacitor is switched out of the circuit, the resonant frequency reverts to the discrete resonant frequency of the resonant capacitor H. Thus, by switching the switching capacitor into and out of the circuit a representative signal 170 as shown in FIG. 3 is produced.

As the resonant frequency of the tag is changed, a corresponding change in frequency is measured at receiver coil B which is then delivered to controller output 44 and controller 40.

These signals can be processed using known techniques to produce a digital output shown representatively as 150 (binary signal 111) and 180 (binary signal 101) in FIG. 3. Through appropriate coding and controller interpretation as known to those skilled in the art, the signals can be interpreted and utilized to provide useful output such as whether a desired product pairing is authentic or not.

### Coded Information

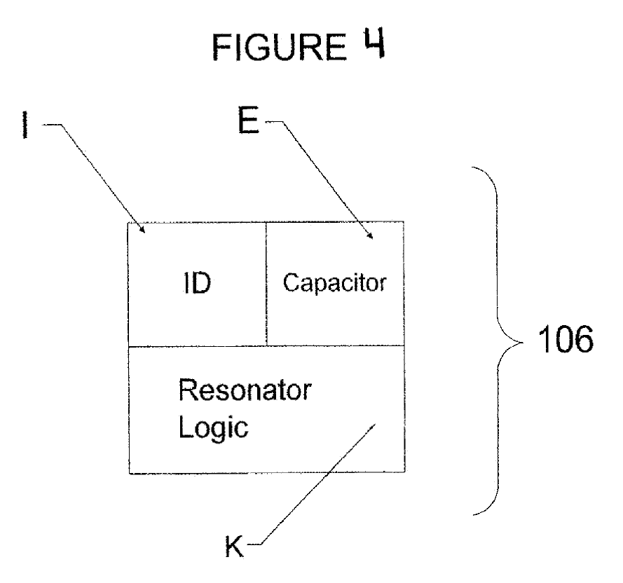

With reference to FIG. 4, an embodiment of the tag circuit is described that enables unique read-only identification codes or coded information to be incorporated into the tag circuit. As shown, an identification system 106 includes identification logic I, switching capacitor E and resonator logic K.

The identification system 106 generally controls the timing of when the switching capacitor E is switched into and out of the circuit. More specifically, when the system is oscillating, the resonator logic K detects the oscillation and then begins to switch the switching capacitor into and out of the circuit. The time at which E is switched into and out of the circuit is determined by the identification logic I. The identification logic I is operatively connected to the resonator logic K such that the output of the reader 101 to 44 produces a patterned frequency corresponding to the identification logic I.

The identification logic I is set during the tag manufacturing process and cannot be changed thereafter. That is, the identification logic is read-only.

In certain embodiments, it is desirable to ensure that no two tags have the same ID code allowing the unique identification of filters.

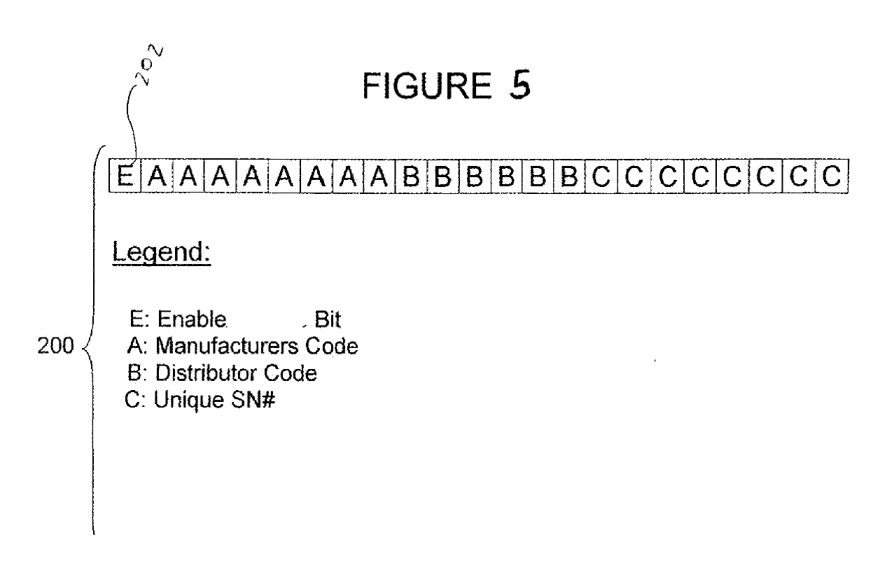

With reference to FIG. 5, a representative example of identification logic 200 is described. It is understood that other identification logic may be utilized as would be understood by those skilled in the art. That is, any number of protocols or techniques can be used to provide a unique identification to various filters.

As shown, the ID code can be subdivided into several sub-sections as depicted in the legend in FIG. 4 including an enable bit 202, a manufacturer's code, a distributor's code and a unique serial number.

In a preferred embodiment, the enable bit is set to a binary 1 during manufacture.

Representative functionality associated with an ID code is described wherein a reader circuit 101 is located in a fluid filtering apparatus and the tag circuit 102 located in the filter. In this example, the fluid filtering apparatus is designed to operate with an approved filter and includes a controller a) enabling the evaluation of data received from the tag circuit, b) enabling the determination of the length of time or amount of use the filter has incurred and c) having the ability to disable the tag circuit.

In operation, a filter is installed within the fluid filtering apparatus such that the reader circuit and tag circuit are physically located adjacent each other. When the fluid filtering system is not in operation, no power is delivered to the reader circuit. When the fluid filtering system enters operation, power is switched on to the reader circuit allowing the reader circuit and tag circuit to interact and tag data or coded information to be received by the reader circuit.

After the reader circuit and tag circuit have reached a steady state (i.e. oscillating), the controller interprets the data received from the tag circuit. For example, the controller may check the enable bit to ensure the tag circuit is allowed to operate within the fluid filtering apparatus or not, and/or the manufacturer, distributor and serial number codes may also be checked. The receipt of information from the tag circuit allows the controller to make operating decisions on the basis of that information.

With respect to the enable bit, if the controller recognizes the enable bit as enabled, the controller may use that information to allow the fluid filtering system to operate normally. If the enable bit has been destroyed or permanently disabled or the tag circuit has been opened, the controller would generally slow or stop fluid flow through the fluid filtering system or provide a visible or audible warning to the user. In a preferred mode of operation, the fluid filtration system will only resume normal operation after the controller detects a new filter with an enable bit that has not been disabled.

In further embodiments, it may be desirable to render a tag inoperable so as to ensure that the fluid filtration system is operating under the manufacturer's guidelines. For example, it may be desirable for the controller to disable a tag circuit after a filter has been used for a specific period of time, amount of use or other criteria set by the manufacturer or if unacceptable levels of contaminants are found downstream of the filter. Furthermore, the controller may disable the tag circuit if the pressure upstream or downstream of the filtering apparatus exceeds pre-determined limits. Appropriate calculations and control mechanisms can be implemented to prevent the use of a filter within a fluid filter apparatus if pre-determined conditions of operation are exceeded or violated. In preferred embodiments, the tag circuit can be rendered inoperable by permanently disabling or destroying the enable bit or by blowing a fuse within the tag circuit.

In a first preferred embodiment, the enable bit may be permanently disabled or destroyed in order to render the tag circuit inoperable. In particular, a shift register can be used to isolate a path to the enable bit during a series of clock cycles. Once a path to the enable bit has been established, the reader circuit may emit a high voltage pulse (for example 30V) that will permanently destroy the enable bit. If a reader circuit subsequently tries to couple with the tag circuit, the identification logic will read the enable bit as a 0. The controller may then take appropriate action such as slowing or stopping fluid flow through the filter or providing a warning to the user.

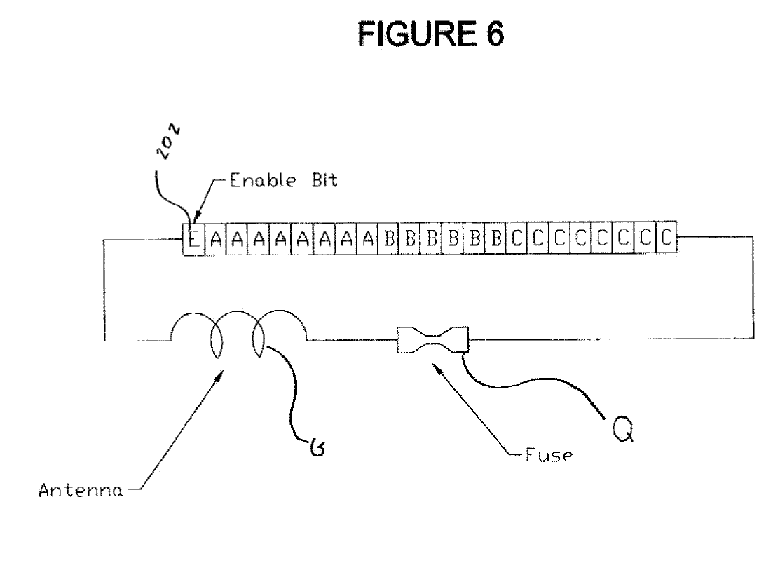

Referring to FIG. 6, in a second preferred embodiment, a read-only tag may include a fuse embedded within the tag circuit. The fuse may be located such that when the fuse is blown, the tag circuit will become inoperable. To make the tag inoperable, the reader circuit may emit a high voltage pulse (for example 30V). If the voltage pulse exceeds the rated voltage of the fuse, the voltage will cause one or more fuse elements to melt or fuse creating an open circuit in the tag circuit. The open circuit will prevent the tag circuit from coupling to and being read by the reader circuit. As a result, the reader circuit will not be able to read the filter serial number. The controller may subsequently take appropriate action such as slowing or stopping fluid flow through the filter.

In preferred embodiments of the invention, the tag circuit will be designed to operate at values in the 1V to 6V range and be disabled in the 25V to 35V range with an accompanying increase in current although it is understood that the operating voltage range and disablement voltage range can be expanded if required by the design of specific fluid filtration systems.

Other codes, including a manufacturer's code can be included to allow different manufacturers of a similar product to have customized identifications. Such information may be beneficial to ensure that only those manufacturers with approved codes are producing filters to be used within a fluid filtering apparatus.

The use of other coded information such as a distributor's code allows a manufacturer to sub-divide approval for the sale or use of filters within a particular geographical jurisdiction. For example, a manufacturer may license a distributor to sell filters within a particular jurisdiction and not outside that jurisdiction. By incorporating a distributor code within a tag, a manufacturer can ensure that filters can be used in specific jurisdictions only by denying those filters having an incorrect distribution code from operating within certain fluid filtering apparatuses.

A unique serial number can also be added to allow for further information to be delivered back to various databases for data evaluation, data mining, and other purposes.

In still further embodiments, the reader may be operatively connected to the internet enabling the manufacturer to query the fluid filtering system for consumption monitoring so as to enable efficient delivery of replacement filter to a user. For example, in a fluid filtering system connected to a network, the reader and tag system can monitor filter use and automatically report that consumption information over the network to a manufacturer who can deliver a replacement filter before the current filter needs replacement.

The manufacture and bulk cost of the technology described herein is significantly advantaged over past radio frequency (RF) systems wherein the reader circuit and tag circuit can be manufactured from commonly available, low cost materials as well as custom low cost CMOS and Application Specific Integrated Circuit (ASIC) components. Tag circuit 102 and the reader circuit can be mass produced with the result that the unit cost of the tag and reader circuits are very economical.

Importantly, the tag circuit does not require its own power supply as the tag circuit receives sufficient energy from the reader circuit through the coupling process. Moreover, the reader circuit can be powered by a small low voltage (3 volt) DC battery that in many applications could provide sufficient power for several years of operation.

Although the present invention has been described and illustrated with respect to preferred embodiments and preferred uses thereof, it is not to be so limited since modifications and changes can be made therein which are within the full, intended scope of the invention as understood by those skilled in the art.

What is claimed is:

1. A system allowing the wireless transfer of data between a fluid filtering apparatus and a filter when the filter is positioned within the fluid filtering apparatus, the system comprising:
a reader circuit operatively connected to the fluid filtering apparatus, the reader circuit having a controller;
a tag circuit operatively connected to the filter for passive wireless communication with the reader circuit, the tag circuit containing coded read-only information readable by the reader circuit authorizing use of the filter with the fluid filtering apparatus, and wherein the tag circuit includes an enable bit responsive to a disable signal from the reader circuit to permanently de-authorize use of the filter with the fluid filtering apparatus.

2. A system as in claim 1 wherein the disable signal is a high-voltage signal from the reader circuit that causes a permanent change in the enable bit.

3. A system as in claim 1 wherein the enable bit is isolated during a clock cycle by a shift register and the reader circuit emits a high voltage pulse to destroy the enable bit.

4. A system as in claim 3 wherein upon enable bit destruction, the controller controls fluid flow through the filter and/or provides a visible or audible warning to the user.

5. A system as in claim 4 wherein the controller will re-enable fluid flow only upon recognition of a new filter having a different serial number and enable bit.

6. A system as in claim 1 wherein the controller initiates deactivation of the enable bit based on detection of time-of-use or volume-of-use in excess of pre-determined parameters of use for a filter from a manufacturer.

7. A system as in claim 1 wherein the controller initiates deactivation of the enable bit based on detection of one or more downstream sensor parameters in excess of pre-determined limits of use for a filter from a manufacturer.

8. A system as in claim 1 wherein the tag circuit includes an antenna and a fuse operatively connected to the antenna, the fuse being responsive to a disable signal to permanently disable the tag circuit.

9. A system as in claim 1 where the controller is operatively connected to the Internet and wherein any one of or a combination of time-of-use, volume-of-use or downstream sensor parameters are reported to a manufacturer over the Internet.

10. A system as in claim 1 wherein the reader circuit includes a receiver coil and a transmit coil for providing oscillation energy to the tag circuit when the tag circuit is coupled to the reader circuit.

11. A system as in claim 10 wherein the tag circuit has a tag coil for patterned oscillation at least two discrete frequencies and for coupling to the reader circuit such that the receiver coil, transmit coil and tag coil all oscillate at the same frequency when the reader circuit and tag circuit are coupled and the patterned oscillation is representative of coded information within the tag circuit.

12. A system as in claim 1 wherein the controller initiates a visual or auditory signal if a filter needs to be replaced or is not appropriate for use in the fluid filtration apparatus.

13. A system as in claim 1 wherein power for the tag circuit is obtained from the oscillation energy from the reader circuit.

14. A system as in claim 1 wherein the tag circuit is permanently disabled based on commands from the controller in response to pre-determined criteria measured downstream of the filter.

15. A method of changing the status of a filter in a fluid filtration apparatus, the fluid filtration apparatus having a controller and a reader circuit operatively coupled to a tag circuit in which the tag circuit is operatively connected to the filter, the method comprising the steps of:
a) isolating an enable bit within tag identification logic within the tag circuit; and
b) applying a disable signal to enable in order to permanently destroy the enable bit.

16. A method of changing the status of a filter in a fluid filtration apparatus, the fluid filtration apparatus having a controller and a reader circuit operatively coupled to a tag circuit in which the tag circuit is operatively connected to the filter and the tag circuit has a fuse, the method comprising the step of applying a high voltage pulse to the tag circuit to destroy the fuse and to open the tag circuit.
